(19) United States
(12) Patent Application Publication
(10) Pub. No.: US 2018/0085824 A1
(43) Pub. Date: Mar. 29, 2018

(54) METHOD FOR PROCESSING METAL POWDER

(71) Applicants: Jürgen Scholz, Munich (DE); Ernst Miklos, Kirchheim (DE); Jim Fieret, Orpington (GB); Pierre Foret, Munich (DE)

(72) Inventors: Jürgen Scholz, Munich (DE); Ernst Miklos, Kirchheim (DE); Jim Fieret, Orpington (GB); Pierre Foret, Munich (DE)

(21) Appl. No.: 15/716,748

(22) Filed: Sep. 27, 2017

(30) Foreign Application Priority Data
Sep. 29, 2016 (DE) 10 2016 011 705.2

(51) Int. Cl. B22F 1/00; B01J 2/04; C01B 23/00; C01B 3/00

(52) U.S. Cl. CPC B22F 1/0048; B01J 2/04; B22F 2009/0876; C01B 3/00; C01B 23/0052

(57) ABSTRACT

A method for processing powdered starting materials includes a powdered material created and packaged under a protective gas atmosphere such that a protective gas is also present in the package, and the packaged powdered material is unpacked by a user and sent for further processing, wherein a gas detectable with sensors is supplied to the protective gas during packaging and/or in the packaging, or the protective gas is a gas that can be detected with sensors and the manufacturer and packager of the powdered material and/or the end user will examine the package with sensors to detect an escape of the detectable gas.

The present invention relates to a method for processing metal powder, in particular for further processing in metallurgical powder processes or generative production processes.

There are numerous methods for producing metal powder. These include mechanical pulverization of solid metal, deposition from saline solutions, thermal decomposition of a chemical compound, reduction of a chemical compound, usually the oxide in solid phase, electrolytic deposition and atomization of molten metal. The three processes mentioned last are the ones used most commonly in practice to produce metal powder.

in atomization, molten metal is fragmented into small droplets and solidified rapidly before the droplets of melt come in contact with one another or with a solid surface. The principle of this process is based on fragmentation of a thin stream of molten metal through a gas or liquid stream at a high velocity. Air, nitrogen and argon are the gases used most commonly, while mainly water is used as the liquid.

Other methods for fragmenting a melt are being used to an increasing extent, such as centrifugal atomization, in which droplets of melt are flung outward from a rotating source.

Whereas atomization of water is used for the production of powders from iron, steel, copper and copper alloys in particular, the atomization of aluminum and zinc are the main processes used, and atomization of copper is carried out in air in some cases.

For compressed air atomization, first a melt of the metal to be atomized or the alloy to be atomized is produced and superheated accordingly. This superheated melt usually runs over a second smaller crucible or a sprue, where it forms a stream of melt which drops perpendicularly through a nozzle construction. The stream of melt is atomized by a gas (carrier gas), and the resulting droplets solidify in an atomization chamber during the movement. The metal powder is separated from the carrier gas in the atomization chamber and/or in a downstream gas purification line (cyclone, filter).

Steel melts produced by the LD refining method with a low degree of carbonization are preferably used in industrial production of powdered steel by atomization in water. Another option for production of powdered steel consists of using sorted scrap metal and melting it in an electric arc furnace.

High-purity powders of special steel, superalloys and other highly alloyed and/or oxidation-sensitive materials can be produced advantageously by atomization with inert gas. This process usually yields spherical powders which are hardly suitable for processing by isostatic pressing and/or excellently suited for that processing and for powder spray casting.

The ASEA-STORA method for atomizing fast-working steel melts is often used on a large scale industrially. By using purified inert gases such as N₂ and Ar, and working in a closed system it is possible to produce powder with approximately 100 ppm oxygen. To increase the cooling rate of the metal droplets, the atomization chamber is cooled from the outside and a water-cooled bottom is used to collect the powder.

Another method includes atomization with gases in a Laval nozzle according to Nanoval GmbH & Co. KG. To produce a pure spherical metal powder from reactive metals, such as titanium or zirconium, methods which do not allow contact of the molten metal with ceramic crucible material are advantageous because ceramic crucible material could result in oxidation of the melt and possible destruction of the crucible. Therefore, the reactive metal is smelted inductively or by means of plasma in a cooled copper crucible. Then a thin solidified layer of the metal to be atomized is formed between the copper crucible and the melt, effectively preventing a reaction of the melt with the crucible material.

Another possibility for ceramic-free atomization of metal, which is suitable for reactive materials in particular and is used in the production of titanium powder, for example, is the EIGA method. In this method, the metal to be atomized and/or the alloy to be atomized is/are supplied as an electrode in bar form perpendicular to an annular induction coil and is melted there superficially. To ensure uniform melting, the bar is subject to a rotational movement during the process. The melt thereby produced ultimately drops in freefall through an annular nozzle, where it is atomized and solidifies. Next, the powder is deposited n an atomization container.

Likewise, plasma atomization is used for production of pure spherical titanium and titanium alloy powder. A wire with a diameter of approximately 3 mm produced from the alloy to be atomized is sent to an arrangement of three plasma burners, where it is melted and atomized in one step. Due to the purity of the starting materials, the lack of any crucible material and the melting under an inert atmosphere, an end product of the highest purity is obtained.

Distribution of melts in vacuo, which would in principle also count as a type of atomization, is possible with the help of noble gases or hydrogen. The melt, which is enriched with the gas under pressure, is forced in a thin stream into an evacuated chamber. Expansion of the gas dissolved in the melt divides the melt into fine droplets.

Metal powders are frequently subjected to an annealing treatment after they are produced. It is necessary to reduce the powder for example when the powder particles have oxidized at the surface more or less as a result of prolonged or unfavorable storage (elevated moisture content and temperature). The reduction is performed in a traditional way also for the furnaces used for sintering. Most often pure hydrogen and ammonia cracking gas are used as the reducing atmosphere.

With the known methods for processing metal powders, in particular in generative manufacturing methods and so-called “additive manufacturing (AM),” it is necessary for the metal powder to have the most reactive possible surface, and in particular there should not be any superficial oxidation of the metal powder.

One of the methods within the scope of additive manufacturing is powder bed technology in general, in which the powder is arranged inside a chamber, and the chamber is flushed with a protective gas while a laser has a melting or sintering effect on the powder and a component is produced from this and then subjected to a layer-by-layer Laser treatment accordingly.

On the whole, the selective laser melting (SLM), selective laser sintering (SLS), selective heat sintering (SHS) and electron beam melting (EBM) are known methods. Electron beam melting, selective laser sintering and selective laser melting are similar methods such that in selective laser melting the metal powder is applied to a base plate in a thin layer and is re-melted completely by means of a laser beam, thus forming a solid layer of material. Then the base plate is lowered by the amount of one layer thickness and the metal powder is applied again, the cycle being repeated until all the layers have been re-melted in the desired manner.

In laser sintering, the material is also built up layer-by-layer, wherein the powder is applied to the full surface of a component platform and then the respective parts of the layer are processed with a laser beam, later forming the component.

In electron beam melting, these steps are carried out by an electron beam accordingly instead of a laser beam.

In addition to generative production processes, there are other production processes in which metal powders are used. These include in particular hot isostatic pressing (HIP), sintering, thermal spraying, plasma spraying and other processes that can also be mentioned.

All these methods have in common the fact that they are relatively sensitive for the surrounding atmosphere and in particular are sensitive to impurities in the atmosphere, in particular oxygen.

Many of these methods are therefore carried out under a protective gas atmosphere.

The object of the invention is to create a method by which such metal powders can be produced and processed to yield a higher quality.

This object is achieved with a method having the features of the claims.

Advantageous refinements are characterized by the dependent claims.

According to the invention, it has been recognized that production processes often take place under a protective gas atmosphere, but the supply chain has so far been disregarded in the processing of these powders.

However, the supply chain is particularly important because it includes not only the shipping of the powders but also the packaging of the powders, the storage of the powders and the unpacking and further processing of the powders.

Depending on the processing rate and delivery rate, such metal powders thus often remain in the supply chain much longer than in production or processing. Contamination of these powders and in particular negative effects at the surface of the powder can thus occur to a particular extent during the supply chain and/or in the supply chain.

With these technologies, it is known that the powder quality—not only the quality of the alloys per se or the grain size distribution but also the surface quality of the powder particles—is a significant factor in the production of a high-quality product.

In particular it has been observed that relatively great fluctuations may occur from one batch to the next, and fluctuations in the quality of the metal powder as well as the intermediate product and also the metallic component, i.e., the end product, may lead to complaints on the part of the processor or the end user if the quality is too low.

It is thus in the vital interest of the powder manufacturer to ensure the powder quality on a long-term basis and verifiably up to the site of processing and to also be able to document this quality.

To do so, one must be able to document such standardized quality sequences. In the past, it was often necessary to perform chemical analyses for such quality assurance tests that could detect any impurities or defects in the quality of a powder in the supply chain.

In the past, vacuum packaging has been used, allowing the user to ascertain whether or not there is still a vacuum. Furthermore, protective argon gas fillings have been provided in such types of packaging, wherein the packaging may appear undamaged but in fact may no longer contain any argon due to leaks.

The inventors have recognized that both vacuum packaging and the argon packaging have disadvantages. Vacuum packaging may experience a loss of vacuum due to even minor damage, but vacuum packaging is always at risk of an influx of oxygen, in which case it would then no longer be possible to ascertain when the packaging was damaged.

According to the invention, hydrogen or helium may be added to the packaging atmosphere, which consists of argon or nitrogen or mixtures thereof, for example. When using hydrogen, the amount added must of course be kept below the possible explosion limits, which is usually when the hydrogen content is less than 4%, as measured by the total atmosphere.

In addition, hydrogen cannot be used with steel powder because all grades of steel tend to cause hydrogen embrittlement and incorporate hydrogen particularly well, but then release it again, although such a release usually does not occur at a time when it is desired.

The advantage of hydrogen or helium is that they can be used as leakage indicators, wherein their molecular size is advantageous, making it possible to detect a small leakage at a much earlier point in time than to measure or detect a pressure loss in the case of argon or nitrogen. According to the invention, so-called electronic noses or sensors which are provided can also detect even tiny amounts of escaping hydrogen or helium, which make it possible for the operator to prevent a defective package with potentially damaged metal powder from entering production.

In addition, it is even possible to determine the leakage rate of the hydrogen or helium and to record that for any packaging.

Electronic noses can be used at the manufacturer's end to ascertain whether the seal on a package is sufficient or to detect possible leaks at the consumer end. This may advantageously eliminate downtime due to a poor-quality intermediate product.

In addition, with these types of packaging with helium or hydrogen, the packaging atmosphere can be introduced into the package under pressure. Before opening such a package, it would then be necessary either to operate a valve, which would release the excess pressure to the exterior in a manner that is clearly perceptible by the end user, indicating an undamaged package, or a package part such as a cover, which is pre-stressed by the excess pressure, so that, by touching this area, it is possible to ascertain whether or not an excess pressure still prevails. It is advantageous here in particular that even the smallest leaks can be detected in a particularly noticeable manner due to the excess pressure and the “identifying gas” hydrogen or helium escaping from the package.

The method according to the invention thus includes the step of packaging metallic powders or even nonmetallic powders, such as ceramic or plastic powders, in particular for generative manufacturing methods, in a protective gas atmosphere using a gas which includes hydrogen and/or helium for detecting package leaks.

Furthermore, the method possibly includes a step in which the package is inspected for quality control at the manufacturer's end; the package is monitored for hydrogen or helium escaping and/or for “identifying gas” by means of sensors and/or

a method step in which packages arriving at the processor's plant are also checked for leaks with sensors and/or

in both cases a leakage rate is determined for the case when certain packages unavoidably have very small leaks.

According to the invention, up to 4% hydrogen or helium in a protective gas comprising argon, nitrogen or mixtures thereof may be used as the protective gas.

When using helium, it is also possible to use pure helium but gas mixtures containing 5% to 100% helium may also be used in particular.

It is especially preferred with the invention that the manufacturer and the user both use the same detection methods and in particular use the same measurement equipment to determine the identifying gases used and optionally even determine the leakage rates of these gases.

It is additionally preferable that the manufacturer and. the consumer are interconnected, so that the measuring devices are networked to be able to detect any differences, and so that not just nominal values are determined but also comparative values can be determined. In the case of comparative values in particular, an error signal can then be output when there are comparative values.

The invention also includes a gas mixture for leakage detection on packages of a metallic powder for the generative manufacturing method, wherein the gas mixture contains 1% to 4% hydrogen and/or 5% to 100% helium, with the remainder being nitrogen and/or argon.

According to the invention, the gas mixture can be mixed to form a complete mixture in corresponding containers or mixed just before packaging by combining two or more components at the site of the packaging of the metal powder and then packaged under this atmosphere and/or the gas may be added to the package or pumped into it.

The invention also comprises an airtight container for conveying a gas mixture and/or the metal powder, wherein the container is fixed or flexible and contains an atmosphere according to the claims.

The invention also relates to a method for quality assurance in packaging, shipping and unpackaging metal powders, in particular metal powders for generative production based on the differential leakage detection in the packaging station of the manufacturer and/or the dealer and/or the recipient/user, wherein the gas atmosphere with which the metal powder is packaged can be detected with sensors and the leakage detection data can be compared such that the powder is packaged under a gas atmosphere which has a defined composition and a gas leakage is measured optionally after the packaging, a lot number of the packaged metal and the packaging, the composition of the gas, the result of the leakage detection are confirmed by the packager and stored digitally in a cloud, wherein the recipient of the packaging uses the same leakage detection equipment and compares his measurement of gas leaks with the data in the cloud.

This method according to the invention can be improved upon by, to simplify the comparison, using leakage detection equipment capable of transferring the data directly to the cloud or to a mobile data transmission device, which communicates with the cloud.

What is claimed is:

1. A method for processing powdered starting materials for generative manufacturing methods, comprising:
producing and packaging a powdered material under a protective gas atmosphere;
providing a protective gas in the packaging for the powdered material;
unpacking the packaged powdered material and sending the packaged powdered material for further processing;
supplying a gas that is detectable by sensors to the protective as during at least one of the packaging, and in a package for the powdered material; and
testing the package with sensors for the escape of the gas by at least one of manufacturers and packagers of the powdered material, and an end user of the powdered material.

2. The method according to claim 1, wherein the packaging occurs under the protective gas using the gas detectable by the sensors, and further comprising at least one of a vacuum, atmospheric pressure, and an excess pressure results in the package.

3. The method according to claim 1, wherein the gas that is detectable by the sensors is selected from the group consisting of hydrogen (H), and helium (He).

4. The method according to claim 4, wherein the gas selected and used comprises up to 4% hydrogen, and up to 100% helium.

5. The method according to claim further comprising:
providing an interior pressure-sensitive region on the packaging; and
haptically detecting at least one of a prevailing reduced pressure in the package, and a prevailing excess pressure in the package.

6. The method according to claim 1, further comprising:
providing an interior pressure-sensitive region on the packaging; and
optically detecting at least one of a prevailing reduced pressure in the package, and a prevailing excess pressure in the package.

7. The method according to claim 1, further comprising:
providing an exterior pressure-sensitive region on the packaging; and
haptically detecting at least one of a prevailing reduced pressure in the package, and a prevailing excess pressure in the package.

8. The method according to claim 1, further comprising:
providing an exterior pressure-sensitive region on the packaging; and
optically detecting at least one of a prevailing reduced pressure in the package, and a prevailing excess pressure in the package.

9. The method according to claim 1, further comprising:
testing the package at a time selected from one of after the packaging by a manufacturer, and before unpacking by the end user, wherein the testing comprises using electronic noses for detecting escaping gas detectable with the sensors, and determining an amount of the escaping gas that is detected by the sensors; and
comparing values of the escaping gas with one another.

10. The method according to claim 1, further comprising:
testing the package after the packaging by a manufacturer and before unpacking by the end user, wherein the testing comprises using electronic noses for detecting escaping gas detectable with the sensors, and determining an amount of the escaping gas that is detected by the sensors; and
comparing values of the escaping gas with one another.

11. A gas mixture for leakage detection from packages of a metallic powder for a generative manufacturing process, comprising a gas mixture including gases selected from the group consisting of from 1% to 4% hydrogen, from 5% to 100% helium, the combination of from 1% to 4% hydrogen and from 5% to 100% helium; and a remainder of nitrogen.

12. The gas mixture according to claim 11, wherein the gas mixture comprises a finished mixture including at least two of the gases, the finished mixture prepared at a packaging site for the metallic powder and packaged in corresponding containers.

13. A container for transporting a gas mixture used for processing powdered starting materials for generative manufacturing, wherein the container construction is airtight and fixed, and comprises an atmosphere therein of a gas mixture including gases selected from the group consisting of from 1% to 4% hydrogen, from 5% to 100% helium, the combination of from 1% to 4% hydrogen and from 5% to 100% helium; and a remainder of nitrogen.

14. A container for transporting a gas mixture used for processing powdered starting materials for generative manufacturing, wherein the container construction is airtight and flexible, and comprises an atmosphere therein of a gas mixture including gases selected from the group consisting of from 1% to 4% hydrogen, from 5% to 100% helium, the combination of from 1% to 4% hydrogen and from 5% to 100% helium; and a remainder of nitrogen.

15. A method for quality assurance in packaging, shipping and unpacking of metallic powders for generative manufacturing, based on differential leakage detection at a packaging station of a manufacturer, dealer and/or recipient-user of the metallic powders, wherein a gas atmosphere with which the metallic powders are packaged are detectable by sensors, and leakage detection data is compared, wherein the powder is packaged under a gas atmosphere having a defined composition, and a gas leak is optionally measured after packaging, a lot number of the packaged metal and the package indicating the composition of the gas, the result of the leakage detection is saved by the packager and stored digitally in cloud computing, and wherein, the recipient-user of the packaging uses the same leakage detection equipment and compares his measurement of gas leakages with data stored in the cloud computing.

16. The method according to claim 15, wherein leakage detection devices capable of transmitting data directly to the cloud computing, and to a mobile data transmission device which communicates with the cloud, are used to simplify the comparison.
